(19) United States
(12) Patent Application Publication
(10) Pub. No.: US 2026/0152607 A1
(43) Pub. Date: Jun. 4, 2026

(54) BLACK MATTE POLYIMIDE FILM

(71) Applicant: TAIMIDE TECHNOLOGY INCORPORATION, Hsinchu Hsien (TW)

(72) Inventors: YUNG-CHU CHUANG, Hsinchu Hsien (TW); MENG-YING TSAI, Hsinchu Hsien (TW); TING-XUAN DENG, Hsinchu Hsien (TW)

(73) Assignee: TAIMIDE TECHNOLOGY INCORPORATION, Hsinchu Hsien (TW)

(21) Appl. No.: 19/403,265

(22) Filed: Nov. 28, 2025

(30) Foreign Application Priority Data
Nov. 29, 2024 (TW) 113146335

(51) Int. Cl. C08G 73/10; C08J 5/18; C08K 3/04

(52) U.S. Cl. CPC C08G 73/1007; C08J 5/18; C08K 3/04; C08J 2379/08

(57) ABSTRACT

A black matte polyimide film is provided, which comprises a polyimide in an amount of 71-89 wt %, where the polyimide is obtained by chemical cyclization of polyamic acid formed by the polymerization of diamine and dianhydride; a carbon black in an amount of 2-9 wt %, where the median particle size (D₅₀) of the carbon black is less than 1 μm; and a polyimide matting agent in an amount of 9-20 wt %, where the polyimide matting agent is composed of polyimide particles with a median particle size of 0.3-4 μm; wherein the black matte polyimide film has an elongation at break of more than 15%, a peak height (Spk) of less than 300 nm, a 60-degree gloss level of less than 30 GU, and a total optical transmittance of less than 1%.

### CROSS-REFERENCE TO RELATED APPLICATION

This non-provisional application claims priority under 35 U.S.C. § 119 (a) on Patent Application No(s). 113146335 filed in Taiwan, R.O.C. on Nov. 29, 2024, the entire contents of which are hereby incorporated by reference.

### BACKGROUND OF THE INVENTION

### 1. Field of the Invention

The present disclosure relates to a black matte polyimide film, specifically a black matte polyimide film containing a polyimide matting agent. The polyimide matting agent is composed of polyimide particles of a specific particle size, where the specific particle size refers to the median particle size of the polyimide particles constituting the polyimide matting agent being in a range of 0.3 μm to 4 μm.

### 2. Description of the Related Art

Polyimide films are often used as a cover layer for flexible circuit boards. Among the polyimide films, black matte polyimide film is often used in special flexible circuit boards due to its special optical properties.

In recent years, with the increasing performance and functionality of electronic devices, there is still a demand for a cover layer that can maintain electrical insulation properties even at high frequencies, while also retaining acceptable structural and optical properties to provide protection for electronic components and avoid unnecessary visual inspection and damage.

However, conventional black matte polyimide films mainly use carbon black as a pigment and dye to reduce light transmittance, thereby achieving the functions of covering and protection. In addition, colored polyimide films, due to their color, will produce a lot of reflected light on their surface. Therefore, matting agents are added to reduce the gloss level of the film.

### BRIEF SUMMARY OF THE INVENTION

To further reduce the gloss level of polyimide films, the particle size and proportion of the added matting agent are important factors. Currently known polyimide particulate matting agents have a particle size range of approximately 2 to 8 micrometers. When added at a rate of 1.6 to 9% by weight, they can achieve a low gloss level of less than 30 GU at 60 degrees. However, if the matting agent particles are large, there will be more instances of the matting agent particles protruding from the film surface, which will reduce the elongation at break of the film, resulting in a decrease in its mechanical strength. This will make the film more prone to cracking during production, reduce the production yield, and cause too many protruding film surfaces due to the large matting agent particles. This will lead to inaccurate thickness detection of the film during the production process, which will greatly reduce the production quality.

Furthermore, when large matting agent particles are applied to polyimide films with a relatively small thickness, the film's elongation at break will decrease, leading to easy breakage and reduced production yield during the production process.

To overcome the problem of excessively large matting agent particles being used in thinner polyimide films, a matting agent with a smaller particle size can be used. This reduces the protrusion of the matting agent onto the film surface, improving the film's elongation at break and making film thickness detection more accurate. However, reducing the particle size of the matting agent may increase the film's gloss level, failing to meet the product's low-gloss level requirements. To overcome this problem, research on the particle size and dosage of the matting agent is an important topic in the research of matting polyimide films.

To address the aforementioned issues, this disclosure proposes a black matte polyimide film that possesses a high elongation at break and a low peak height, while also achieving a low gloss level.

The present disclosure relates to a black matte polyimide film, comprising: a polyimide, where the amount of the polyimide is in a range of 71-89 wt %, based on the total weight of the black matte polyimide film, and the polyimide is obtained by chemical cyclization of polyamic acid formed by the polymerization of diamine and dianhydride;
a carbon black, where the amount of the carbon black is in a range of 2-9 wt %, based on the total weight of the black matte polyimide film, and the median particle size (D₅₀) of the carbon black is less than 1 μm; and
a polyimide matting agent, where the amount of the polyimide matting agent is in a range of 9-20 wt %, based on the total weight of the black matte polyimide film, and the polyimide matting agent is composed of polyimide particles with a median particle size of 0.3-4 μm;
where the black matte polyimide film has a peak height (Spk) of less than 300 nm, a 60-degree gloss level of less than 30 GU, and a total optical transmittance of less than 1%.

In a preferred embodiment of the present disclosure, the polyimide matting agent comprises a first polyimide matting agent and a second polyimide matting agent,
where the amount of the first polyimide matting agent is in a range of 80-95 wt %, based on the total weight of the polyimide matting agent, and the first polyimide matting agent is composed of polyimide particles with a median particle size (D₅₀) of 0.3-1 μm, and
where the amount of the second polyimide matting agent is in a range of 5-20 wt %, based on the total weight of the polyimide matting agent, and the second polyimide matting agent is composed of polyimide particles with a median particle size (D₅₀) of 1-4 μm,
where the black matte polyimide film has an 85-degree gloss level of less than 50 GU.

In a preferred embodiment of the present disclosure, the maximum particle size (D₉₉) of the polyimide particles in the polyimide matting agent is less than 5 μm.

In a preferred embodiment of the present disclosure, the black matte polyimide film has a thickness of less than 30 μm and an elongation at break of more than 15%.

In a preferred embodiment of the present disclosure, the black matte polyimide film has a thickness of less than 10 μm.

### DETAILED DESCRIPTION OF THE INVENTION

The black matte polyimide film comprises polyamic acid, polyimide matting agent, and carbon black. The polyimide matting agent and carbon black are each formulated into a slurry, and the slurries are mixed with polyamic acid and subjected to a chemical cyclization process to cyclize the polyamic acid into polyimide.

The aforementioned chemical cyclization refers to the cyclization of polyamic acid to form polyimide when a catalyst or a dehydrating agent or both are used simultaneously.

### Preparation of Polyamic Acid

Polyamic acid is obtained by polymerizing diamine and dianhydride in an organic solvent.

The diamine may be selected from p-phenylenediamine (PDA), 4,4′-diaminodiphenyl ether (ODA), 2,2′-dimethyl-4,4′-diaminobiphenyl (mTB), 4,4′-diaminobenzanilide (44DABA), 5-amino-2-(4-aminophenyl)benzoxazole (5BPOA), 4,4′-bis(4-aminophenoxy) biphenyl (BAPB), 4-aminophenyl 4-aminobenzoate (APAB), 1,3-bis(3-aminophenoxy)benzene (APB-N), 1,4-bis(4-aminophenoxy)benzene (TPEQ), 1,3-bis(4-aminophenoxy)benzene (TPER), and combinations thereof.

The dianhydride can be selected from pyromellitic dianhydride (PMDA), 3,3′,4,4′-biphenyltetracarboxylic dianhydride (BPDA), 4,4′-(4,4′-isopropylidenediphenoxy) phthalic anhydride (BPADA), 4,4′-oxodiphthalic anhydride (ODPA), 3,3′,4,4′-benzophenone tetracarboxylic dianhydride (BTDA), 1,4-phenylenebis (1,3-dioxo-1,3-dihydroisobenzofuran-5-carboxylate) (TAHQ), and combinations thereof.

The aforementioned aromatic diamine can be a combination of p-phenylenediamine (PDA) and 4,4′-diaminodiphenyl ether (ODA).

The aforementioned aromatic dianhydride can be pyromellitic dianhydride (PMDA) or 3,3′,4,4′-biphenyltetracarboxylic dianhydride (BPDA).

As a solvent, dimethylacetamide (DMAc), N-methylpyrrolidone (NMP), N-ethyl-2-pyrrolidone (NEP), γ-butyrolactone (GBL), and N,N-dimethylformamide (DMF) can be used in the preparation of polyamic acid. In this embodiment, dimethylacetamide is used as a solvent.

### Preparation of Carbon Black Slurry

Carbon black and dimethylacetamide were mixed in a weight ratio of 1:7 to form a solution. After stirring evenly, the solution was shaken with an ultrasonic vibrator for 1 hour to complete the carbon black slurry.

The carbon black in the aforementioned carbon black slurry is insulating carbon black.

The weight ratio of carbon black to dimethylacetamide in the aforementioned carbon black slurry can be adjusted as needed. The weight ratio of carbon black is related to optical transmittance and dielectric loss factor. If the proportion of carbon black is too high, the dielectric loss factor will increase. In the black matte polyimide film of the present disclosure, the amount of carbon black is 2-9 wt % based on the total weight of the black matte polyimide film.

### Preparation of Polyimide Matting Agent Slurry

A polyimide matting agent composed of polyimide particles with a median particle size (D₅₀) of 0.3-4 μm was prepared into a solution with dimethylacetamide in a weight ratio of 1:9. After stirring evenly, the solution was ground with 0.5 μm zirconium beads and a zirconium bead filling rate of 50% by volume. The grinding time was 30 minutes to complete the polyimide matting agent slurry.

The aforementioned polyimide matting agent preferably includes a first polyimide matting agent and a second polyimide matting agent.

The aforementioned first polyimide matting agent is preferably composed of polyimide particles with a median particle size in a range of 0.3 μm to 1 μm.

The amount of the aforementioned first polyimide matting agent is preferably 80-95 wt %, based on the total weight of the polyimide matting agent.

The aforementioned second polyimide matting agent is preferably composed of polyimide particles with a median particle size in a range of 1 μm to 4 μm.

The amount of the aforementioned second polyimide matting agent is preferably 5-20 wt %, based on the total weight of the polyimide matting agent.

The weight ratio of polyimide matting agent to dimethylacetamide in the aforementioned polyimide matting agent slurry can be adjusted as needed. The weight ratio of polyimide matting agent is related to gloss level and peak height. If the proportion of polyimide matting agent is too small, the gloss level of the black matte polyimide film will increase. Conversely, it will cause severe graininess on the film surface, resulting in poor finished product appearance and inflated film thickness measurements.

### Preparation of Black Matte Polyimide Film

The aforementioned carbon black slurry, polyimide matting agent slurry, and polyamic acid are mixed and stirred evenly. A catalyst and dehydrating agent are then added for chemical cyclization. The dehydrating agent can be acetic anhydride or benzoic anhydride. In a preferred embodiment of the present disclosure, acetic anhydride is selected as the dehydrating agent. The catalyst can be pyridine, 3-methylpyridine, 2-methylpyridine, 4-methylpyridine, isoquinoline, quinoline, or triethylamine, where pyridine, 3-methylpyridine, 2-methylpyridine, and 4-methylpyridine are preferred. In a preferred embodiment of the present disclosure, 3-methylpyridine is selected as the catalyst.

The catalyst and dehydrating agent mentioned above can be used alone or diluted with a solvent and then added to the mixture. After stirring evenly, the mixture containing the dehydrating agent and catalyst is degassed using a centrifugal degassing machine. The degassed solution is then coated onto a glass substrate using a doctor blade with a 300 μm gap. The coated sample is placed in an 80° C. oven for 20 minutes, then heated to 170° C. for 20 minutes, and finally heated to 350° C. for 20 minutes as the final treatment. After baking, the glass is placed in water, and the film is removed to obtain a black matte polyimide film.

In addition to glass, metal plates can also be used as substrates for the above film-making process. When using a metal plate to make the black matte polyimide film, after baking and drying in an 80° C. oven, a semi-dried film needs to be removed from the metal plate. The semi-dried film is then fixed on a metal frame, and subsequently heated to 170° C. for 20 minutes, and then heated to 350° C. for 20 minutes as the final treatment to obtain the black matte polyimide film.

The thickness of the aforementioned black matte polyimide film is preferably less than 12 μm.

The thickness of the aforementioned black matte polyimide film is more preferably less than 7 μm or even less than 5 μm.

The aforementioned black matte polyimide film can be used as a cover film, which has an adhesive layer and a base layer.

### EXAMPLES

The present disclosure will be specifically described below with reference to embodiments, but the present disclosure is not limited thereto.

### Solvent:

Dimethylacetamide (DMAc): Dimethylacetamide
Acetic anhydride (AA): Acetic anhydride
3-Methylpyridine (AP): 3-Methylpyridine

### Preparation of Polyamic Acid:

7.323 g of p-phenylenediamine (PDA) was added to 425 g of dimethylacetamide (DMAc) and stirred. After the p-phenylenediamine (PDA) dissolved, 25.182 g of 4,4′-diaminodiphenyl ether (ODA) was added. After the 4,4′-diaminodiphenyl ether (ODA) dissolved, 1.138 g of 3,3′, 4,4′-biphenyltetracarboxylic dianhydride (BPDA) was added. After the BPDA dissolved, 40.724 g of pyromellitic dianhydride (PMDA) was slowly added. The temperature was controlled at 25° C. and the reaction was stirred for two hours. The viscosity was adjusted using a small amount of pyromellitic dianhydride (PMDA). Finally, polyamic acid with a solid content of 15% and a viscosity of 223,400 cps was obtained.

### <Test Method>

The properties of the composite membranes obtained in the following examples were measured using the following methods.

Elongation at break: Measured using a Hounsfield H10K-S tensile testing machine in accordance with ASTM D882 specifications.

Optical transmittance: Measured according to ISO 14782 using an instrument of model NDH-2000N manufactured by Nippon Denshoku.

Gloss level: The gloss level was measured at 60 degrees and 80 degrees using a micro-TRI-gloss meter manufactured by BYK.

Peak height (Spk): Measured using a ZegagePLUS instrument manufactured by Zygo.

### Example 1

### Preparation of Polyimide Matting Agent Slurry:

1 g of a second polyimide matting agent (composed of polyimide particles with a median particle size of 2.2 μm) and 9 g of dimethylacetamide (DMAc) were mixed to form a solution. After stirring evenly, the solution was ground with 0.5 μm zirconium beads and a zirconium bead filling rate of 50% by volume to complete the polyimide matting agent slurry.

### Preparation of Carbon Black Slurry:

1 g of carbon black (median particle size: 0.4 μm) and 7 g of dimethylacetamide (DMAc) were mixed to form a solution. After stirring evenly, the solution was shaken with an ultrasonic shaker for 1 hour to complete the carbon black slurry.

### Preparation of Black Matte Polyimide Film:

A mixed slurry was prepared by mixing and stirring evenly 1.637 g of carbon black slurry, 5.116 g of polyimide matting agent slurry, 29.33 g of polyamic acid, and 10.67 g of dimethylacetamide (DMAc). Acetic anhydride (AA) and dimethylacetamide (DMAc) were diluted at a weight ratio of 2:1 to prepare the AA diluent. 3-methylpyridine (AP) and dimethylacetamide (DMAc) were then diluted at a weight ratio of 1:1 to prepare the AP diluent. 5.02 mL of the AA diluent and 3.33 mL of the AP diluent were then added to the mixed slurry. After mixing evenly, the mixture was degassed using a centrifuge. The degassed solution was then poured onto a glass substrate and coated using a doctor blade with a 300 μm gap. The coated sample was placed in an 80° C. oven and baked for 20 minutes. Then, the temperature was increased to 170° C. at a rate of 1.8° C./min and baked for another 20 minutes. Finally, the temperature was increased to 350° C. at a rate of 2.0° C./min and baked for another 20 minutes as the final treatment.

A glass substrate was immersed in water, and a black matte polyimide film with a thickness of 10 μm was peeled off from the glass substrate.

### Example 2

### Preparation of Polyimide Matting Agent Slurry:

1 g of a first polyimide matting agent (composed of polyimide particles with a median particle size of 0.5 μm) and 9 g of dimethylacetamide (DMAc) were mixed to form a solution. After stirring evenly, the solution was ground with 0.5 μm zirconium beads and a zirconium bead filling rate of 50% by volume to complete the polyimide matting agent slurry.

### Preparation of Carbon Black Slurry:

1 g of carbon black (median particle size: 0.4 μm) and 7 g of dimethylacetamide (DMAc) were mixed to form a solution. After stirring evenly, the solution was shaken with an ultrasonic shaker for 1 hour to complete the carbon black slurry.

### Preparation of Black Matte Polyimide Film:

A mixed slurry was prepared by mixing and stirring evenly 1.738 g of carbon black slurry, 8.148 g of polyimide matting agent slurry, 29.33 g of polyamic acid, and 10.67 g of dimethylacetamide (DMAc). Acetic anhydride (AA) and dimethylacetamide (DMAc) were diluted at a weight ratio of 2:1 to prepare the AA diluent. 3-methylpyridine (AP) and dimethylacetamide (DMAc) were then diluted at a weight ratio of 1:1 to prepare the AP diluent. 5.02 mL of the AA diluent and 3.33 mL of the AP diluent were then added to the mixed slurry. After mixing evenly, the mixture was degassed using a centrifuge. The degassed solution was then poured onto a glass substrate and coated using a doctor blade with a 300 μm gap. The coated sample was placed in an 80° C. oven and baked for 20 minutes. Then, the temperature was increased to 170° C. at a rate of 1.8° C./min and baked for another 20 minutes. Finally, the temperature was increased to 350° C. at a rate of 2.0° C./min and baked for another 20 minutes as the final treatment.

A glass substrate was immersed in water, and a black matte polyimide film with a thickness of 10 μm was peeled off from the glass substrate.

### Example 3

### Preparation of Polyimide Matting Agent Slurry:

0.81 g of a first polyimide matting agent (composed of polyimide particles with a median particle size of 0.5 μm), 0.19 g of a second polyimide matting agent (composed of polyimide particles with a median particle size of 3 μm) and 9 g of dimethylacetamide (DMAc) were mixed to form a solution. After stirring evenly, the solution was ground with 0.5 μm zirconium beads and a zirconium bead filling rate of 50% by volume to complete the polyimide matting agent slurry.

### Preparation of Carbon Black Slurry:

1 g of carbon black (median particle size: 0.4 μm) and 7 g of dimethylacetamide (DMAc) were mixed to form a solution. After stirring evenly, the solution was shaken with an ultrasonic shaker for 1 hour to complete the carbon black slurry.

### Preparation of Black Matte Polyimide Film:

A mixed slurry was prepared by mixing and stirring evenly 1.628 g of carbon black slurry, 4.832 g of polyimide matting agent slurry, 29.33 g of polyamic acid, and 10.67 g of dimethylacetamide (DMAc). Acetic anhydride (AA) and dimethylacetamide (DMAc) were diluted at a weight ratio of 2:1 to prepare the AA diluent. 3-methylpyridine (AP) and dimethylacetamide (DMAc) were then diluted at a weight ratio of 1:1 to prepare the AP diluent. 5.02 mL of the AA diluent and 3.33 mL of the AP diluent were then added to the mixed slurry. After mixing evenly, the mixture was degassed using a centrifuge. The degassed solution was then poured onto a glass substrate and coated using a doctor blade with a 300 μm gap. The coated sample was placed in an 80° C. oven and baked for 20 minutes. Then, the temperature was increased to 170° C. at a rate of 1.8° C./min and baked for another 20 minutes. Finally, the temperature was increased to 350° C. at a rate of 2.0° C./min and baked for another 20 minutes as the final treatment.

A glass substrate was immersed in water, and a black matte polyimide film with a thickness of 9 μm was peeled off from the glass substrate.

### Example 4

### Preparation of Polyimide Matting Agent Slurry:

0.83 g of a first polyimide matting agent (composed of polyimide particles with a median particle size of 0.5 μm), 0.17 g of a second polyimide matting agent (composed of polyimide particles with a median particle size of 3 μm) and 9 g of dimethylacetamide (DMAc) were mixed to form a solution. After stirring evenly, the solution was ground with 0.5 μm zirconium beads and a zirconium bead filling rate of 50% by volume to complete the polyimide matting agent slurry.

### Preparation of Carbon Black Slurry:

1 g of carbon black (median particle size: 0.4 μm) and 7 g of dimethylacetamide (DMAc) were mixed to form a solution. After stirring evenly, the solution was shaken with an ultrasonic shaker for 1 hour to complete the carbon black slurry.

### Preparation of Black Matte Polyimide Film:

A mixed slurry was prepared by mixing and stirring evenly 1.647 g of carbon black slurry, 5.404 g of polyimide matting agent slurry, 29.33 g of polyamic acid, and 10.67 g of dimethylacetamide (DMAc). Acetic anhydride (AA) and dimethylacetamide (DMAc) were diluted at a weight ratio of 2:1 to prepare the AA diluent. 3-methylpyridine (AP) and dimethylacetamide (DMAc) were then diluted at a weight ratio of 1:1 to prepare the AP diluent. 5.02 mL of the AA diluent and 3.33 mL of the AP diluent were then added to the mixed slurry. After mixing evenly, the mixture was degassed using a centrifuge. The degassed solution was then poured onto a glass substrate and coated using a doctor blade with a 300 μm gap. The coated sample was placed in an 80° C. oven and baked for 20 minutes. Then, the temperature was increased to 170° C. at a rate of 1.8° C./min and baked for another 20 minutes. Finally, the temperature was increased to 350° C. at a rate of 2.0° C./min and baked for another 20 minutes as the final treatment.

A glass substrate was immersed in water, and a black matte polyimide film with a thickness of 9 μm was peeled off from the glass substrate.

### Example 5

### Preparation of Polyimide Matting Agent Slurry:

0.93 g of a first polyimide matting agent (composed of polyimide particles with a median particle size of 0.5 μm), 0.07 g of a second polyimide matting agent (composed of polyimide particles with a median particle size of 3 μm) and 9 g of dimethylacetamide (DMAc) were mixed to form a solution. After stirring evenly, the solution was ground with 0.5 μm zirconium beads and a zirconium bead filling rate of 50% by volume to complete the polyimide matting agent slurry.

### Preparation of Carbon Black Slurry:

1 g of carbon black (median particle size: 0.4 μm) and 7 g of dimethylacetamide (DMAc) were mixed to form a solution. After stirring evenly, the solution was shaken with an ultrasonic shaker for 1 hour to complete the carbon black slurry.

### Preparation of Black Matte Polyimide Film:

A mixed slurry was prepared by mixing and stirring evenly 1.637 g of carbon black slurry, 5.116 g of polyimide matting agent slurry, 29.33 g of polyamic acid, and 10.67 g of dimethylacetamide (DMAc). Acetic anhydride (AA) and dimethylacetamide (DMAc) were diluted at a weight ratio of 2:1 to prepare the AA diluent. 3-methylpyridine (AP) and dimethylacetamide (DMAc) were then diluted at a weight ratio of 1:1 to prepare the AP diluent. 5.02 mL of the AA diluent and 3.33 mL of the AP diluent were then added to the mixed slurry. After mixing evenly, the mixture was degassed using a centrifuge. The degassed solution was then poured onto a glass substrate and coated using a doctor blade with a 300 μm gap. The coated sample was placed in an 80° C. oven and baked for 20 minutes. Then, the temperature was increased to 170° C. at a rate of 1.8° C./min and baked for another 20 minutes. Finally, the temperature was increased to 350° C. at a rate of 2.0° C./min and baked for another 20 minutes as the final treatment.

A glass substrate was immersed in water, and a black matte polyimide film with a thickness of 9 μm was peeled off from the glass substrate.

### Example 6

### Preparation of Polyimide Matting Agent Slurry:

0.85 g of a first polyimide matting agent (composed of polyimide particles with a median particle size of 0.5 μm), 0.15 g of a second polyimide matting agent (composed of polyimide particles with a median particle size of 3 μm) and 9 g of dimethylacetamide (DMAc) were mixed to form a solution. After stirring evenly, the solution was ground with 0.5 μm zirconium beads and a zirconium bead filling rate of 50% by volume to complete the polyimide matting agent slurry.

### Preparation of Carbon Black Slurry:

1 g of carbon black (median particle size: 0.4 μm) and 7 g of dimethylacetamide (DMAc) were mixed to form a solution. After stirring evenly, the solution was shaken with an ultrasonic shaker for 1 hour to complete the carbon black slurry.

### Preparation of Black Matte Polyimide Film:

A mixed slurry was prepared by mixing and stirring evenly 1.676 g of carbon black slurry, 6.286 g of polyimide matting agent slurry, 29.33 g of polyamic acid, and 10.67 g of dimethylacetamide (DMAc). Acetic anhydride (AA) and dimethylacetamide (DMAc) were diluted at a weight ratio of 2:1 to prepare the AA diluent. 3-methylpyridine (AP) and dimethylacetamide (DMAc) were then diluted at a weight ratio of 1:1 to prepare the AP diluent. 5.02 mL of the AA diluent and 3.33 mL of the AP diluent were then added to the mixed slurry. After mixing evenly, the mixture was degassed using a centrifuge. The degassed solution was then poured onto a glass substrate and coated using a doctor blade with a 300 μm gap. The coated sample was placed in an 80° C. oven and baked for 20 minutes. Then, the temperature was increased to 170° C. at a rate of 1.8° C./min and baked for another 20 minutes. Finally, the temperature was increased to 350° C. at a rate of 2.0° C./min and baked for another 20 minutes as the final treatment.

A glass substrate was immersed in water, and a black matte polyimide film with a thickness of 9 μm was peeled off from the glass substrate.

### Example 7

### Preparation of Polyimide Matting Agent Slurry:

0.91 g of a first polyimide matting agent (composed of polyimide particles with a median particle size of 0.5 μm), 0.09 g of a second polyimide matting agent (composed of polyimide particles with a median particle size of 3 μm) and 9 g of dimethylacetamide (DMAc) were mixed to form a solution. After stirring evenly, the solution was ground with 0.5 μm zirconium beads and a zirconium bead filling rate of 50% by volume to complete the polyimide matting agent slurry.

### Preparation of Carbon Black Slurry:

1 g of carbon black (median particle size: 0.4 μm) and 7 g of dimethylacetamide (DMAc) were mixed to form a solution. After stirring evenly, the solution was shaken with an ultrasonic shaker for 1 hour to complete the carbon black slurry.

### Preparation of Black Matte Polyimide Film:

A mixed slurry was prepared by mixing and stirring evenly 1.320 g of carbon black slurry, 9.350 g of polyimide matting agent slurry, 29.33 g of polyamic acid, and 10.67 g of dimethylacetamide (DMAc). Acetic anhydride (AA) and dimethylacetamide (DMAc) were diluted at a weight ratio of 2:1 to prepare the AA diluent. 3-methylpyridine (AP) and dimethylacetamide (DMAc) were then diluted at a weight ratio of 1:1 to prepare the AP diluent. 5.02 mL of the AA diluent and 3.33 mL of the AP diluent were then added to the mixed slurry. After mixing evenly, the mixture was degassed using a centrifuge. The degassed solution was then poured onto a glass substrate and coated using a doctor blade with a 700 μm gap. The coated sample was placed in an 80° C. oven and baked for 20 minutes. Then, the temperature was increased to 170° C. at a rate of 1.8° C./min and baked for another 20 minutes. Finally, the temperature was increased to 350° C. at a rate of 2.0° C./min and baked for another 20 minutes as the final treatment.

A glass substrate was immersed in water, and a black matte polyimide film with a thickness of 25 μm was peeled off from the glass substrate.

### Comparative Example 1

### Preparation of Polyimide Matting Agent Slurry:

0.81 g of a first polyimide matting agent (composed of polyimide particles with a median particle size of 0.5 μm), 0.19 g of a second polyimide matting agent (composed of polyimide particles with a median particle size of 3 μm) and 9 g of dimethylacetamide (DMAc) were mixed to form a solution. After stirring evenly, the solution was ground with 0.5 μm zirconium beads and a zirconium bead filling rate of 50% by volume to complete the polyimide matting agent slurry.

### Preparation of Carbon Black Slurry:

1 g of carbon black (median particle size: 2.5 μm) and 7 g of dimethylacetamide (DMAc) were mixed to form a solution. After stirring evenly, the solution was shaken with an ultrasonic shaker for 1 hour to complete the carbon black slurry.

### Preparation of Black Matte Polyimide Film:

A mixed slurry was prepared by mixing and stirring evenly 1.628 g of carbon black slurry, 4.832 g of polyimide matting agent slurry, 29.33 g of polyamic acid, and 10.67 g of dimethylacetamide (DMAc). Acetic anhydride (AA) and dimethylacetamide (DMAc) were diluted at a weight ratio of 2:1 to prepare the AA diluent. 3-methylpyridine (AP) and dimethylacetamide (DMAc) were then diluted at a weight ratio of 1:1 to prepare the AP diluent. 5.02 mL of the AA diluent and 3.33 mL of the AP diluent were then added to the mixed slurry. After mixing evenly, the mixture was degassed using a centrifuge. The degassed solution was then poured onto a glass substrate and coated using a doctor blade with a 300 μm gap. The coated sample was placed in an 80° C. oven and baked for 20 minutes. Then, the temperature was increased to 170° C. at a rate of 1.8° C./min and baked for another 20 minutes. Finally, the temperature was increased to 350° C. at a rate of 2.0° C./min and baked for another 20 minutes as the final treatment.

A glass substrate was immersed in water, and a black matte polyimide film with a thickness of 12 μm was peeled off from the glass substrate.

### Comparative Example 2

### Preparation of Polyimide Matting Agent Slurry:

0.58 g of a first polyimide matting agent (composed of polyimide particles with a median particle size of 0.5 μm), 0.42 g of a second polyimide matting agent (composed of polyimide particles with a median particle size of 3 μm) and 9 g of dimethylacetamide (DMAc) were mixed to form a solution. After stirring evenly, the solution was ground with 0.5 μm zirconium beads and a zirconium bead filling rate of 50% by volume to complete the polyimide matting agent slurry.

### Preparation of Carbon Black Slurry:

1 g of carbon black (median particle size: 0.4 μm) and 7 g of dimethylacetamide (DMAc) were mixed to form a solution. After stirring evenly, the solution was shaken with an ultrasonic shaker for 1 hour to complete the carbon black slurry.

### Preparation of Black Matte Polyimide Film:

A mixed slurry was prepared by mixing and stirring evenly 1.628 g of carbon black slurry, 4.832 g of polyimide matting agent slurry, 29.33 g of polyamic acid, and 10.67 g of dimethylacetamide (DMAc). Acetic anhydride (AA) and dimethylacetamide (DMAc) were diluted at a weight ratio of 2:1 to prepare the AA diluent. 3-methylpyridine (AP) and dimethylacetamide (DMAc) were then diluted at a weight ratio of 1:1 to prepare the AP diluent. 5.02 mL of the AA diluent and 3.33 mL of the AP diluent were then added to the mixed slurry. After mixing evenly, the mixture was degassed using a centrifuge. The degassed solution was then poured onto a glass substrate and coated using a doctor blade with a 300 μm gap. The coated sample was placed in an 80° C. oven and baked for 20 minutes. Then, the temperature was increased to 170° C. at a rate of 1.8° C./min and baked for another 20 minutes. Finally, the temperature was increased to 350° C. at a rate of 2.0° C./min and baked for another 20 minutes as the final treatment.

A glass substrate was immersed in water, and a black matte polyimide film with a thickness of 12 μm was peeled off from the glass substrate.

### Comparative Example 3

### Preparation of Polyimide Matting Agent Slurry:

0.83 g of a first polyimide matting agent (composed of polyimide particles with a median particle size of 0.5 μm), 0.17 g of a second polyimide matting agent (composed of polyimide particles with a median particle size of 3 μm) and 9 g of dimethylacetamide (DMAc) were mixed to form a solution. After stirring evenly, the solution was ground with 0.5 μm zirconium beads and a zirconium bead filling rate of 50% by volume to complete the polyimide matting agent slurry.

### Preparation of Carbon Black Slurry:

1 g of carbon black (median particle size: 0.4 μm) and 7 g of dimethylacetamide (DMAc) were mixed to form a solution. After stirring evenly, the solution was shaken with an ultrasonic shaker for 1 hour to complete the carbon black slurry.

### Preparation of Black Matte Polyimide Film:

A mixed slurry was prepared by mixing and stirring evenly 1.530 g of carbon black slurry, 1.913 g of polyimide matting agent slurry, 29.33 g of polyamic acid, and 10.67 g of dimethylacetamide (DMAc). Acetic anhydride (AA) and dimethylacetamide (DMAc) were diluted at a weight ratio of 2:1 to prepare the AA diluent. 3-methylpyridine (AP) and dimethylacetamide (DMAc) were then diluted at a weight ratio of 1:1 to prepare the AP diluent. 5.02 mL of the AA diluent and 3.33 mL of the AP diluent were then added to the mixed slurry. After mixing evenly, the mixture was degassed using a centrifuge. The degassed solution was then poured onto a glass substrate and coated using a doctor blade with a 300 μm gap. The coated sample was placed in an 80° C. oven and baked for 20 minutes. Then, the temperature was increased to 170° C. at a rate of 1.8° C./min and baked for another 20 minutes. Finally, the temperature was increased to 350° C. at a rate of 2.0° C./min and baked for another 20 minutes as the final treatment.

A glass substrate was immersed in water, and a black matte polyimide film with a thickness of 13 μm was peeled off from the glass substrate.

### Comparative Example 4

### Preparation of Polyimide Matting Agent Slurry:

0.88 g of a first polyimide matting agent (composed of polyimide particles with a median particle size of 0.05 μm), 0.12 g of a second polyimide matting agent (composed of polyimide particles with a median particle size of 3 μm) and 9 g of dimethylacetamide (DMAc) were mixed to form a solution. After stirring evenly, the solution was ground with 0.5 μm zirconium beads and a zirconium bead filling rate of 50% by volume to complete the polyimide matting agent slurry.

### Preparation of Carbon Black Slurry:

1 g of carbon black (median particle size: 0.4 μm) and 7 g of dimethylacetamide (DMAc) were mixed to form a solution. After stirring evenly, the solution was shaken with an ultrasonic shaker for 1 hour to complete the carbon black slurry.

### Preparation of Black Matte Polyimide Film:

A mixed slurry was prepared by mixing and stirring evenly 1.738 g of carbon black slurry, 8.148 g of polyimide matting agent slurry, 29.33 g of polyamic acid, and 10.67 g of dimethylacetamide (DMAc). Acetic anhydride (AA) and dimethylacetamide (DMAc) were diluted at a weight ratio of 2:1 to prepare the AA diluent. 3-methylpyridine (AP) and dimethylacetamide (DMAc) were then diluted at a weight ratio of 1:1 to prepare the AP diluent. 5.02 mL of the AA diluent and 3.33 mL of the AP diluent were then added to the mixed slurry. After mixing evenly, the mixture was degassed using a centrifuge. The degassed solution was then poured onto a glass substrate and coated using a doctor blade with a 300 μm gap. The coated sample was placed in an 80° C. oven and baked for 20 minutes. Then, the temperature was increased to 170° C. at a rate of 1.8° C./min and baked for another 20 minutes. Finally, the temperature was increased to 350° C. at a rate of 2.0° C./min and baked for another 20 minutes as the final treatment.

A glass substrate was immersed in water, and a black matte polyimide film with a thickness of 13 μm was peeled off from the glass substrate.

### Comparative Example 5

### Preparation of Polyimide Matting Agent Slurry:

0.81 g of a first polyimide matting agent (composed of polyimide particles with a median particle size of 0.5 μm), 0.19 g of a second polyimide matting agent (composed of polyimide particles with a median particle size of 7 μm) and 9 g of dimethylacetamide (DMAc) were mixed to form a solution. After stirring evenly, the solution was ground with 0.5 μm zirconium beads and a zirconium bead filling rate of 50% by volume to complete the polyimide matting agent slurry.

### Preparation of Carbon Black Slurry:

1 g of carbon black (median particle size: 0.4 μm) and 7 g of dimethylacetamide (DMAc) were mixed to form a solution. After stirring evenly, the solution was shaken with an ultrasonic shaker for 1 hour to complete the carbon black slurry.

### Preparation of Black Matte Polyimide Film:

A mixed slurry was prepared by mixing and stirring evenly 1.628 g of carbon black slurry, 5.116 g of polyimide matting agent slurry, 29.33 g of polyamic acid, and 10.67 g of dimethylacetamide (DMAc). Acetic anhydride (AA) and dimethylacetamide (DMAc) were diluted at a weight ratio of 2:1 to prepare the AA diluent. 3-methylpyridine (AP) and dimethylacetamide (DMAc) were then diluted at a weight ratio of 1:1 to prepare the AP diluent. 5.02 mL of the AA diluent and 3.33 mL of the AP diluent were then added to the mixed slurry. After mixing evenly, the mixture was degassed using a centrifuge. The degassed solution was then poured onto a glass substrate and coated using a doctor blade with a 550 μm gap. The coated sample was placed in an 80° C. oven and baked for 20 minutes. Then, the temperature was increased to 170° C. at a rate of 1.8° C./min and baked for another 20 minutes. Finally, the temperature was increased to 350° C. at a rate of 2.0° C./min and baked for another 20 minutes as the final treatment.

A glass substrate was immersed in water, and a black matte polyimide film with a thickness of 18 μm was peeled off from the glass substrate.

The following table compares the Examples with the Comparative examples:

TABLE 1

| | | | Polyimide matting agent | | | | | | |
|---|---|---|---|---|---|---|---|---|---|
| | | | First polyimide | | Second polyimide | | | | |
| | Carbon black | | matting agent | | matting agent | | Polyimide matting agent | | |
| | Median | | Median | | Median | | Median | Maximum | |
| | particle | | particle | | particle | | particle | particle | |
| | size(D₅₀) | Amount | size(D₅₀) | Amount | size(D₅₀) | Amount | size(D₅₀) | size (D₉₉) | Amount |
| | μm | wt % | μm | wt % | μm | wt % | μm | μm | wt % |
| Example 1 | 0.4 | 4 | — | — | 2.2 | 100% | 2.2 | — | 10 |
| Example 2 | 0.4 | 4 | 0.5 | 100% | — | — | 0.5 | — | 15 |
| Example 3 | 0.4 | 4 | 0.5 | 81% | 3 | 19% | 1.6 | 2 | 9.5 |
| Example 4 | 0.4 | 4 | 0.5 | 83% | 3 | 17% | 1.3 | 2 | 10.5 |
| Example 5 | 0.4 | 4 | 0.5 | 93% | 3 | 7% | 0.8 | 2 | 10 |
| Example 6 | 0.4 | 4 | 0.5 | 85% | 3 | 15% | 1.2 | 2 | 12 |
| Example 7 | 0.4 | 3 | 0.5 | 91% | 3 | 9% | 1.2 | 2 | 17 |
| Comparative | 2.5 | 4 | 0.5 | 81% | 3 | 19% | 1.6 | 2 | 9.5 |
| Example 1 | | | | | | | | | |
| Comparative | 0.4 | 4 | 0.5 | 58% | 3 | 42% | 2 | 2 | 9.5 |
| Example 2 | | | | | | | | | |
| Comparative | 0.4 | 4 | 0.5 | 83% | 3 | 17% | 1.6 | 2 | 4 |
| Example 3 | | | | | | | | | |
| Comparative | 0.4 | 4 | 0.05 | 88% | 3 | 12% | 0.5 | 1.5 | 15 |
| Example 4 | | | | | | | | | |
| Comparative | 0.4 | 4 | 0.5 | 81% | 7 | 19% | 3.2 | 9 | 10 |
| Example 5 | | | | | | | | | |

| | | Elongation | Gloss level | Gloss level | Optical | Peak height |
|---|---|---|---|---|---|---|
| | Thickness | at break | (60) | (85) | transmittance | (Spk) |
| | μm | % | GU | GU | % | nm |
| Example 1 | 10 | 48 | 20 | 40 | 0.5 | 223 |
| Example 2 | 10 | 35 | 18 | 65 | 0.5 | 285 |
| Example 3 | 9 | 45 | 23 | 48 | 0.6 | 173 |
| Example 4 | 9 | 48 | 20 | 42 | 0.7 | 180 |
| Example 5 | 9 | 43 | 23 | 45 | 0.8 | 179 |
| Example 6 | 9 | 40 | 15 | 40 | 0.4 | 200 |
| Example 7 | 25 | 55 | 25 | 43 | 0.4 | 251 |
| Comparative | 12 | 30 | 19 | 41 | 0.1 | 356 |
| Example 1 | | | | | | |
| Comparative | 12 | 10 | 5 | 15 | 0.4 | 550 |
| Example 2 | | | | | | |
| Comparative | 13 | 50 | 60 | 72 | 0.4 | 150 |
| Example 3 | | | | | | |
| Comparative | 13 | 50 | 53 | 62 | 0.4 | 223 |
| Example 4 | | | | | | |
| Comparative | 18 | 5 | 2 | 10 | 0.4 | 843 |
| Example 5 | | | | | | |

In Table 1, the amount of carbon black refers to the weight percentage (wt %) of carbon black based on the total weight of the black matte polyimide film; the amount of polyimide matting agent refers to the weight percentage (wt %) of polyimide matting agent based on the total weight of the black matte polyimide film.

In Table 1, the amount of the first polyimide matting agent refers to the weight percentage (wt %) of the first polyimide matting agent based on the total weight of the polyimide matting agent; the amount of the second polyimide matting agent refers to the weight percentage (wt %) of the second polyimide matting agent based on the total weight of the polyimide matting agent.

As shown in Table 1, it can be confirmed that the black matte polyimide film manufactured according to the examples of the present disclosure not only exhibits excellent optical properties, but also has a lower peak height, making it less prone to bumps on the film surface and maintaining good mechanical properties.

As can be seen from Examples 3 to 6, the gloss level performance of the black matte polyimide film can be controlled by adjusting the ratio between two polyimide matting agents with different median particle sizes. The closer the gloss level values of 60 degrees and 85 degrees are, the more consistent the appearance of the film material is when viewed from any angle.

Comparative Example 1 shows that when the median particle size of carbon black is too large, the bumps on the film surface increase, which in turn leads to a peak height greater than 300 nm.

Comparative Example 2 shows that when the proportion of the second polyimide matting agent is too high, it will cause an increase in bumps on the film surface. These bumps will cause defects in the film, resulting in an elongation at break of less than 15%.

Comparative Example 3 shows that when the amount of polyimide matting agent is too low, the gloss level of the film will be greater than 30 GU.

Comparative Example 4 shows that when the median particle size of the polyimide particles in the polyimide matting agent is too small, it cannot produce a matting effect on the film surface.

Comparative Example 5 shows that when the median particle size of the polyimide particles in the polyimide matting agent or carbon black is too large, it will cause an increase in bumps on the film surface. These bumps will cause defects in the film, resulting in an elongation at break of less than 15%.

The specific embodiments described above are for the purpose of illustrating the present disclosure in detail. However, these embodiments are for illustrative purposes only and are not intended to limit the present disclosure. Those skilled in the art will understand that various changes or modifications made to the present disclosure without departing from the scope defined in the appended claims fall within a part of the present disclosure.

While the present disclosure has been described by means of specific embodiments, numerous modifications and variations could be made thereto by those skilled in the art without departing from the scope and spirit of the present disclosure set forth in the claims.

What is claimed is:

1. A black matte polyimide film, comprising:
a polyimide, wherein an amount of the polyimide is in a range of 71-89 wt %, based on a total weight of the black matte polyimide film, and the polyimide is obtained by chemical cyclization of polyamic acid formed by the polymerization of diamine and dianhydride;
a carbon black, wherein an amount of the carbon black is in a range of 2-9 wt %, based on the total weight of the black matte polyimide film, and a median particle size (D₅₀) of the carbon black is less than 1 μm; and
a polyimide matting agent, wherein an amount of the polyimide matting agent is in a range of 9-20 wt %, based on the total weight of the black matte polyimide film, and the polyimide matting agent is composed of polyimide particles with a median particle size of 0.3-4 μm;
wherein the black matte polyimide film has a peak height (Spk) of less than 300 nm, a 60-degree gloss level of less than 30 GU, and a total optical transmittance of less than 1%.

2. The black matte polyimide film according to claim 1, wherein the polyimide matting agent comprises a first polyimide matting agent and a second polyimide matting agent,
wherein an amount of the first polyimide matting agent is in a range of 80-95 wt %, based on a total weight of the polyimide matting agent, and the first polyimide matting agent is composed of polyimide particles with a median particle size (D₅₀) of 0.3-1 μm, and
wherein an amount of the second polyimide matting agent is in a range of 5-20 wt %, based on the total weight of the polyimide matting agent, and the second polyimide matting agent is composed of polyimide particles with a median particle size (D₅₀) of 1-4 μm,
wherein the black matte polyimide film has an 85-degree gloss level of less than 50 GU.

3. The black matte polyimide film according to claim 1, wherein the maximum particle size (D₉₉) of the polyimide particles in the polyimide matting agent is less than 5 μm.

4. The black matte polyimide film according to claim 1, wherein the black matte polyimide film has a thickness of less than 30 μm and an elongation at break of more than 15%.

5. The black matte polyimide film according to claim 1, wherein the black matte polyimide film has a thickness of less than 10 μm.
